(19) United States
(12) Patent Application Publication
(10) Pub. No.: US 2013/0164426 A1
(43) Pub. Date: Jun. 27, 2013

(54) METHOD OF PROCESSING MEAT

(71) Applicant: Douglas C. D'Apuzzo, Longmont, CO (US)

(72) Inventor: Douglas C. D'Apuzzo, Longmont, CO (US)

(21) Appl. No.: 13/770,651

(22) Filed: Feb. 19, 2013

Related U.S. Application Data
(63) Continuation of application No. 13/257,566, filed on Sep. 19, 2011.

(51) Int. Cl. A23L 1/317

(52) U.S. Cl. CPC A23L 1/317
USPC 426/518

(57) ABSTRACT

A method of processing meat is described. Embodiments of the method include treating a surface of intact meat while leaving a portion of an interior of the piece of intact meat uncooked. Surface treatment can reduce microorganism abundance on the surface. The surface-treated intact meat is subsequently ground. Surface-treatment includes, but is not limited to, heating the surface, irradiating the surface with ionizing or non-ionizing radiation, or treating the surface with an antimicrobial chemical. The surface-treatment prevents or reduces infusing microorganisms throughout the ground meat during grinding, resulting in ground meat that is safe for human consumption without being thoroughly cooked. Accordingly, hamburger or other ground meat can be served rare or otherwise undercooked and be safe for human consumption.

### FIELD OF THE INVENTION

The present invention relates generally to production of ground meat.

### BACKGROUND

Intact meat is typically uncontaminated in its interior, but is prone to microbial contamination on its surface. Contamination can include undesirable microorganisms such as Escherichia Coli (E. Coli), Salmonella, Campylobacter jejuni, Listeria monocytogenes, and Staphylococcus aureus bacteria. Some bacteria found on the surface of intact meat is pathogenic, including but not limited to an 0157:H7 strain of E. Coli, as well as other bacteria listed above. Contamination with pathogenic microorganisms has been responsible for death and widespread illness where people have eaten contaminated meat.

Cooking meat can make the meat safe for human consumption. Because microbial contamination of intact meat is usually limited to the intact meat's surface, cooking an entire surface of intact meat, while leaving a portion of the intact meat uncooked in its interior, is generally sufficient to make the meat safe for human consumption. Accordingly, intact meat can be prepared with a portion of its interior uncooked, so long as the surface is adequately cooked.

Surface contamination of intact meat becomes infused throughout ground meat during grinding of the intact meat. Accordingly, in contrast to intact meat, a mass of ground meat is generally not considered safe for human consumption unless it is very thoroughly cooked. Typically, a mass of ground meat therefore can not be reliably safely served rare or otherwise undercooked because cooking an exterior surface of the ground meat mass while leaving an interior of the mass uncooked is insufficient to disinfect the interior of the ground meat mass.

Because eating a hamburger or other ground meat prepared rare, medium rare, or otherwise undercooked can be highly desirable, and because of the relative difficulty of making ground meat safe for human consumption without cooking it very thoroughly, numerous treatments have been devised to disinfect the ground meat. However, the resulting processes and devices tend to be unsatisfactory because they arc laborious, expensive, or result in a ground meat product that is unpalatable or has otherwise deteriorated.

### BRIEF DESCRIPTION OF THE DRAWINGS

FIG. 1 is a flow chart of a method of processing meat according to one embodiment of the present invention.

FIG. 2 is a flow chart of a method of processing meat according to one embodiment of the present invention.

### DETAILED DESCRIPTION

While there exists in the prior art methods of disinfecting the surface of meat, no prior art contemplates a process that includes grinding meat subsequent surface disinfection in order to produce a hamburger that is safe for human consumption.

Embodiments of the present invention comprise treating a surface of intact meat in order to reduce microbial abundance to a level safe for human consumption, followed by grinding the surface-treated intact meat. The ground meat is also typically safe for human consumption because treatment of the surface of the intact meat prevents surface contamination from being infused throughout the meat during grinding. Accordingly, the resulting ground meat is typically safe for human consumption regardless of subsequent treatment.

Embodiments of the present invention thus enable preparation of undercooked hamburger that is highly palatable and also safe for human consumption. In addition, embodiments of the present invention are relatively simple compared to prior art ground meat processing methods.

Surface treatment of intact meat includes, but is not limited to, thermal treatment, irradiating the surface with ionizing or non-ionizing radiation, or treating the surface with an antimicrobial substance. In some embodiments, the treated surface of the intact meat is subsequently removed prior to grinding the piece of intact meat.

Subsequent to surface treatment, proper sanitary practices, including applications of measures necessary to produce meat with the lowest possible microbial contamination such as personnel hygiene, hygienic work practices, and proper cleaning and sanitization protocols, are implemented in order to prevent or minimize contamination.

Thermally treating the surface of intact meat is typically achieved by means such as, but not limited to, immersing the intact meat in hot fluid, searing the meat surface on a hot solid surface, broiling the meat, and/or treating the intact meat with electromagnetic radiation. For the purposes of this specification and appended claims, hot fluid has a temperature of 145° F. or greater. Electromagnetic radiation used for heating the surface of intact meat is typically non-ionizing radiation such as infrared or microwave radiation, although microwave radiation may also heat an interior of the intact meat such that the resulting intact meat interior becomes cooked. In some embodiments, microwave radiation is focused on a periphery of a mass of intact meat such that the surface of the meat is thermally treated without cooking the interior of the intact meat.

Hot fluids in which intact meat is immersed in order to thermally treat the intact meat surface include fluids such as, but not limited to air, water or aqueous solutions comprising mostly water, and oils. In some embodiments, intact meat is thermally treated by spraying with a hot fluid.

Non-ionizing electromagnetic radiation used to treat the surface of intact meat includes infrared radiation, ultraviolet (UV) radiation, and microwave radiation. Treatment of the surface of intact meat by irradiation with microwave or infrared radiation heats the surface of the intact meat. Accordingly, treatment by microwave or infrared irradiation often includes thermal treatment. Conversely, treatment of the surface of intact meat by irradiation with ultraviolet radiation typically does not effectively heat the surface of the intact meat, and treatment with ultraviolet irradiation, by itself, is thus not a thermal treatment.

In some embodiments, treatment of the surface of intact meat is achieved by irradiation with ionizing electromagnetic radiation. Irradiation with alpha particles can disinfect the surface of intact meat without substantially affecting the intact meat interior. Irradiation with x-rays or gamma-rays typically treats both the interior and exterior of a mass of intact meat. In some embodiments, ionizing radiation such as x-rays or gamma rays, are focused on or immediately proximate a surface of the intact meat in order to minimize irradiation of the interior or the intact meat.

Intact meat is generally considered sufficiently treated for human consumption where the intact meat has been heated to 145° F. or greater for at least 15 seconds. Accordingly, embodiments of the present invention include heating a surface of piece of intact meat to a temperature of 145° F. for at least 15 seconds. In some embodiments, an interior of the piece of intact meat or portion thereof remains uncooked after thermal treatment of the surface. In order to keep a portion of the interior of meat uncooked, heating the surface of the intact meat to 145° or greater is typically limited to a time interval preferably less than 350 seconds, more preferably less than 200 seconds, still more preferably under 150 seconds, and most preferably under 100 seconds.

Embodiments of the present invention can include a quenching step performed after surface treatment of intact meat. Where a piece of intact meat has been thermally treated, quenching typically includes immersing the piece of intact meat in cool fluid. The cool fluid is preferably below 63° F., more preferably between 55° F. and −321° F., still more preferably between 45° F. and −10° F., and most preferably between 35° F. and 28° F. Where thermal treatment includes immersing the piece of intact meat in a hot fluid, a cool fluid resides at a temperature at least 80° F. below a temperature of the hot fluid. Cool fluid includes fluids such as, but not limited to air, water, liquid nitrogen, oil, ice water, and salt water.

Embodiments of the present invention that include chemical treatment can be quenched by neutralizing or diluting an antimicrobial substance that persists on intact meat after chemical treatment. In some embodiments, an antimicrobial chemical or comp is neutralized by immersing a piece of treated, intact meat into water in order to dilute the antimicrobial substance.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, arc not necessarily meant to refer to the same embodiment or the same variation.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

As used in this specification and appended claims, the term “whole-muscle, intact beef” means whole muscle beef that is not injected, mechanically tenderized, reconstructed, or scored and marinated, from which beef steaks may be cut. This definition of “whole muscle, intact beef” is recited verbatim from the US Food and Drug Administration Food Code 2009: Chapter 1—Purpose and Definitions (see http://www.fda.gov/Food/FoodSafety/RetailFoodProtection/FoodCode/FoodCode200 9/ucm186464.htm). For the purposes of this specification and appended claims, beef steaks cut from whole muscle, intact beef can be referred to as whole muscle, intact beef steaks.

The term “intact meat,” and similar terms, as used in this specification and appended claims, refer to a portion of animal muscle meat that has not been ground, shredded, chopped, mechanically tenderized, injected, or restructured. The animal muscle meat includes, but is not limited to beef, lamb, venison, elk, and buffalo. Intact meat includes entire animal carcasses; whole muscle, intact beef and whole muscle intact beef steaks; and other whole muscle, intact animal meat and cuts of meat excised therefrom.

The terms “grind,” “ground,” and similar terms, as used in this specification and appended claims, refer a process of reducing intact meat to small particles. The intact meat can be reduced to small particles by comminuting, mincing, or pulverizing the intact meat. A meat grinder or similar device is typically, but not necessarily, used to reduce the intact meat to small particles. Accordingly, “ground meat” is meat that has been ground, comminuted, minced, pulverized, or otherwise reduced to small particles.

The term “interior,” as used in this specification and appended claims, refers to a portion of a mass of meat located inwardly from the surface of the mass of meat.

The terms “cook,” “cooked”, “cooked meat,” and similar terms, as used in this specification and appended claims, refer to a portion of meat that has reached a temperature of 145° F. or greater for at least 15 seconds. Where a portion of meat has not reached a temperature of 145° F. or greater for at least 15 seconds, that portion of meat is uncooked or undercooked. Terms such as raw, bloody rare, blue rare, very rare, rare, and medium rare refer to meat that is uncooked or undercooked. Where the surface of a piece of meat is cooked but an interior of the meat is uncooked or undercooked, the piece of meat is “partially cooked.” Where an entire mass of meat has reached 145° F. or greater for at least 15 seconds, the mass of meat is “thoroughly cooked.” Where an entire mass of meat has reached 155° F. for at least 15 seconds, the mass of meat is “very thoroughly cooked.” For the purposes of this specification and appended claims, “cooking” and “thermal treatment” are equivalent. Thus where a surface of intact meat is “thermally treated” or “cooked,” the surface of the intact meat has reached a temperature of 145° F. or greater for at least 15 seconds.

The terms “oil,” and “oils,” as used in this specification and appended claims, refer to animal and vegetable lipids, including neutral lipids, phospholipids, triacylglycerols, diacylglycerols, monoacylglycerols, fatty acids, fatty acid esters, and mixtures thereof.

The term “coherent mass,” as used in this specification and appended claims, refers to ground meat that has been pressed or compressed together, or otherwise consolidated, so that it tends to stay in one piece. Examples of coherent masses include, but are not limited to, hamburger patties and meatballs.

The term “chemical treatment,” and similar terms, as used in this specification and appended claims, refers to treating a surface of intact meat with an antimicrobial substance.

The terms “sear,” “seared,” “searing,” and similar terms, as used in this specification and appended claims, refer to thermally treating a surface of a mass of meat by contact between the mass of meat and a solid surface, the solid surface having a temperature greater than 145° F.

The terms “grill,” “grilled,” “grilling,” and similar terms, as used in this specification and appended claims, refer to thermally treating a mass of meat by placing the mass of meat above a heat source. The heat source for grilling is typically, but not necessarily, an open flame. Electric heating elements are also used for grilling. Some heating elements used for grilling arc themselves heated with a flame.

The terms “broil,” “broiled,” “broiling,” and similar terms, as used in this specification and appended claims, refer to thermally treating a surface of intact meat by heating the surface primarily with infra-red radiation. Sources of infra-red radiation include, but are not limited to, electric heating elements and open flames. Methods of broiling typically, but not necessarily, include heating through convection or conduction.

The term “antimicrobial,” “antimicrobial substance,” and similar terms, as used in this specification and appended claims, refers to a substance (or property thereof) that destroys, kills, or inhibits the growth, development, or pathogenic activity of microorganisms. Antimicrobial substances include, but are not limited to, substances having antibacterial or antifungal properties. Soaps and detergents that reduce microorganism abundance merely by reducing adhesion of the microorganisms to a piece of intact meat, in the absence of additional antimicrobial action, do not qualify as antimicrobial substances.

The term “fluid,” as used in this specification and appended claims, refers to one or more gasses, aerosols, liquids, particles, or combinations thereof, which behave generally as a fluid. For the purposes of this specification and appended claims, particles of material in solid phase can constitute a fluid, where those particles are suspended in gas or liquid, or are otherwise adapted to behave as a fluid, i.e. capable of flowing and changing shape at a steady rate when acted upon by a force tending to change the material's shape.

### A First Method of Processing Meat

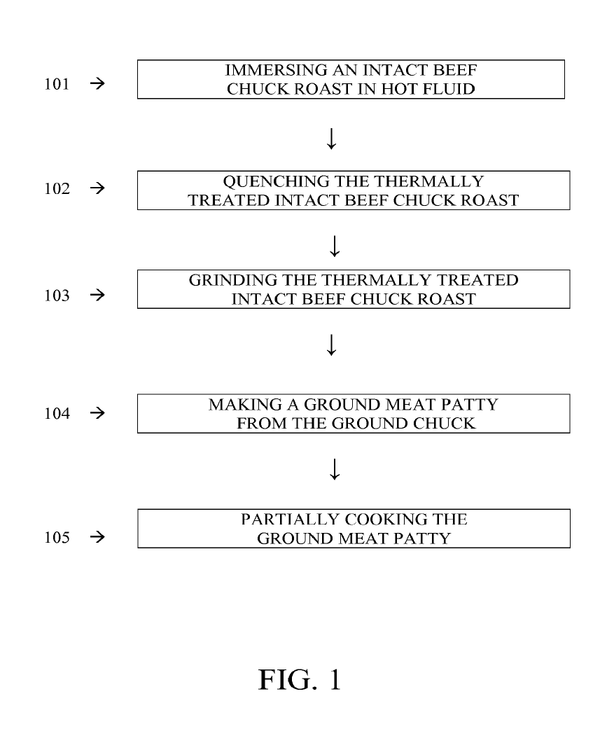

A first method of processing meat is illustrated in FIG. 1. A first operation 101 of the first method of processing meat comprises thermally treating a surface of a piece of intact meat by immersing the piece of intact meat in hot fluid for a specified interval. The piece of intact meat is an intact beef chuck cross rib roast weighing approximately 3.2 pounds.

In some embodiments, the piece of intact meat weighs more or less than 3.2 pounds, and can comprise other animal meat. Variations of intact meat include, but are not limited to, whole animal carcasses, sides or quarters of beef or other animals, or any cut of whole muscle, intact beef that is not injected, mechanically tenderized, reconstructed, or scored and marinated.

The surface of the intact beef chuck cross rib roast is cooked by the immersion in hot fluid, and a portion of the interior of the intact beef chuck cross rib roast remains uncooked. Thus the intact beef chuck cross rib roast is partially cooked. The hot fluid is boiling water and the specified time interval is about 85 seconds. The boiling water is at about 203° F. The thermal treatment disinfects the surface of the intact beef chuck cross rib roast. Variations include water that is 145° or greater, and time intervals can be greater or less than 85 seconds. In some embodiments, the water temperature is less than 172° F.

Temperature of the surface of the intact meat is measured using a Kintrex™ IRT0421 digital non-contact thermometer (Vienna, Va.). In order to measure intact meat surface temperature, the piece of intact meat is removed from the hot fluid, the surface temperature measured, and the piece of intact meat returned to the water. The piece of intact meat is typically removed from the hot fluid for less than four seconds for a temperature measurement. The surface of the piece of intact meat is over 145° F. after being immersed in the hot liquid (water boiling at 203° F.) for 65 seconds. After thermal treatment, proper hygienic and sanitary practices are employed to prevent or minimize microbial contamination of the treated meat.

Where the hot fluid is a liquid, the hot fluid is preferably between 145° F. and 520° F., more preferably between 172° F. and 450° F., and most preferably between 172° F. and 225° F. Variations include hot fluid that resides between 145° F. and 172° F. In some embodiments the hot fluid is an oil such as, but not limited to, canola oil, sunflower oil, safflower oil, corn oil, peanut oil, olive oil, butter, or avocado oil. Variations of hot fluid include gas or mixtures of gasses such as air. In some embodiments, the hot fluid can be above 520° F. For example where the hot fluid comprises steam or water vapor, the hot fluid can be above 520° F.

In some embodiments, thermal treatment of intact meat is achieved by immersing a piece of intact meat in hot corn oil for a specified time interval. Variations include hot corn oil that resides at a temperature of about 450° F. and a specified time interval of about 25 seconds.

A second operation 102 of the first method of processing meat comprises quenching the partially cooked intact beef chuck cross rib roast by immersing it in a cool fluid for a specified cooling interval. The cool fluid of the second operation is ice water at approximately 32° F. and the specified cooling interval is 65 seconds.

A third operation 103 of the first method of processing meat comprises grinding the partially cooked intact beef chuck cross rib roast in a KitchenAid® model FGA meat grinder attached to a KitchenAid® Commercial 5 Series Bowl-Lift Stand Mixer, resulting in ground meat. The ground meat of the first method of processing meat is ground chuck. Variations include other equipment and means for grinding intact meat, including other meat grinders.

A fourth operation 104 of the first method of processing meat includes making a coherent mass by compressing about 6.5 ounces of the ground chuck into a patty, in a manner familiar to persons or ordinary skill in the art. Variations include coherent masses of ground meat other than patties. Coherent masses weighing more or less than 6.5 ounces are also contemplated. Examples of other coherence masses include, but are not limited to, meatballs.

A fifth operation 105 of the first method of processing meat comprises partially cooking the ground meat patty by placing the patty in a hot skillet or grill for approximately two minutes, and subsequently overturning the patty and heating the patty in the hot skillet or grill for another approximately two minutes. The resulting ground meat patty is partially cooked; it is cooked about its periphery and uncooked at its center. In some embodiments, the coherent mass of ground meat is partially cooked by other means, including but not limited to, broiling or deep frying. Variations include coherent masses of ground meat that are not subjected to cooking or partial cooking after grinding.

In the absence of the first operation, which includes thermally treating the surface of the intact beef chuck cross rib roast to reduce microorganism abundance, the partially cooked ground meat patty would be at increased risk of contamination by pathogenic organisms.

### A Second Method of Processing Meat

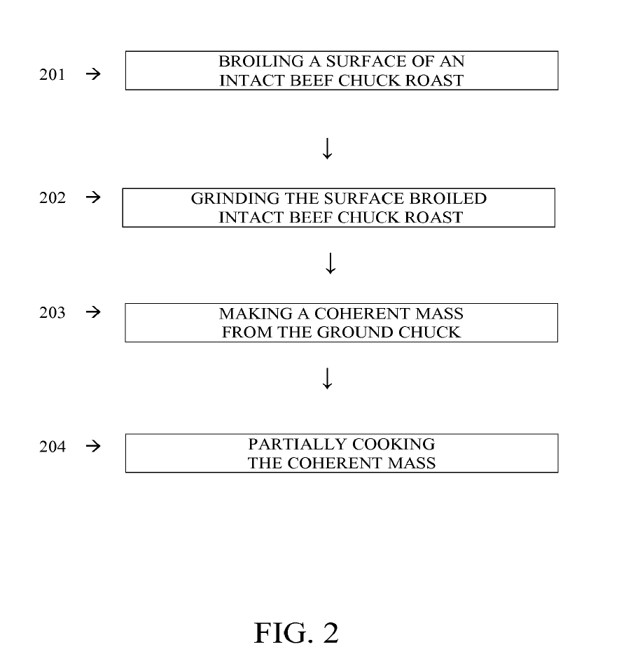

A second method of processing meat is illustrated in FIG. 2. A first operation 201 of the second method of processing meat comprises thermally treating a surface of piece of intact meat, while leaving a portion of an interior of the piece of intact meat uncooked, by broiling the surface of the piece of intact meat. Accordingly, the piece of intact meat becomes partially cooked. The piece of intact meat of the second method of processing meat is an intact beef chuck cross rib roast weighing approximately 3.5 pounds. Broiling is achieved by placing the piece of intact meat on a broiler pan and into a pre-heated Viking® 30″ VEDO Professional Series Double Electric Select Oven set to “broil.” In some embodiments, other ovens or broiling devices are employed to broil intact meat or other intact meat. Variations include devices in which intact meat is disposed between or surrounded by multiple broiling elements. Broiling elements can be powered by electricity, gas, or other power source.

In the second method of processing meat, the surface of the piece of intact meat is positioned approximately four inches to five inches from the heat source. The top surface of the piece of intact meat is exposed to the heat source for approximately two minutes and the piece of intact meat is subsequently turned so that an uncooked portion of the exterior is exposed to the heat source for approximately two minutes. Additional turning of the piece of intact meat is performed until all surfaces of the piece of intact meat are cooked. After thermal treatment, proper hygienic and sanitary practices are employed to prevent or minimize microbial contamination of the treated meat.

A second operation 202 of the second method of processing meat comprises grinding the partially cooked intact meat in a KitchenAid® model FGA meat grinder attached to KitchenAid® Commercial 5 Series Bowl-Lift Stand Mixer, resulting in ground chuck. In some embodiments, the partially cooked intact meat is ground using other equipment or grinding means.

A third operation 203 of the second method of processing meat comprises making a coherent mass from the ground chuck by compressing about 6.5 ounces of the ground chuck into a patty. In some embodiments the ground chuck is eaten without further preparation.

A fourth operation 204 of the second method of processing meat comprises partially cooking the ground meat patty by grilling the patty over an open gas flame for approximately two minutes, and subsequently flipping the patty and grilling it again over an open gas flame for another approximately two minutes. The resulting partially cooked ground meat patty is cooked about its periphery and undercooked in its interior.

### A Third Method of Processing Meat

A third method of processing meat comprises chemical treatment, the chemical treatment including immersing a piece of intact meat in an antimicrobial fluid. The piece of intact meat is an intact beef chuck cross rib roast weighing approximately 3.3 pounds. The antimicrobial fluid includes an aqueous solution comprising 2% by weight formic acid. In some embodiments, the antimicrobial fluid includes other organic acids such as, but not limited to, acetic acid, lactic acid, or propionic acid. Variations of antimicrobial fluids include hydrogen peroxide or combinations of organic acids and hydrogen peroxide. In one embodiment, an antimicrobial fluid comprises an aqueous solution of 2% lactic acid and 1% hydrogen peroxide. In another embodiment, the antimicrobial fluid is a gas comprising 200 ppm ethylene oxide.

The piece of intact meat is immersed in the 2% formic acid for preferably at least 15 seconds, more preferably between 20 seconds and 120 seconds, and most preferably for about 35 seconds. The 2% formic acid is maintained at between 59° F. and 95° F. during immersion of the piece of intact meat. In some embodiments, the antimicrobial fluid is sprayed on the piece of intact meat rather than the piece of meat being immersed in the fluid. Proper hygienic and sanitary practices are employed after chemical treatment, in order to prevent or minimize microbial contamination of the treated meat.

Following treatment with antimicrobial fluid, the piece of intact meat is rinsed with sterile water or saline solution, whereupon the rinsed meat is ground to produce ground meat. Rinsing the intact meat typically includes immersing the meat in sterile water or saline solution or spraying the intact meat with sterile water or saline solution.

The ground meat is formed into a patty, and the patty is prepared “rare,” with a portion of the patty remaining uncooked, by grilling the patty over an open gas flame for approximately two minutes, and subsequently overturning the patty and grilling it again over an open gas flame for another approximately two minutes.

### A Fourth Method of Processing Meat

A fourth method of processing meat comprises treating a piece of intact meat with non-ionizing radiation. The piece of intact meat is an intact beef chuck cross rib roast weighing approximately 3.2 pounds. Non-ionizing radiation of the fourth method is generated by two Philips 9 Watt Sterilamp® PL-S Twin Tube Short Compact Lamps emitting ultraviolet radiation primarily at 254 nm. Variations include other sources of UV radiation, including other electric lamps.

The piece of intact meat is rotated between the two UV lamps at approximately 4.5 rotations per minute for approximately 3.5 minutes. A mean distance between each of the UV lamps and the piece of intact meat is approximately 3.5 inches. Proper hygienic and sanitary practices are employed after treatment with non-ionizing radiation, in order to prevent or minimize microbial contamination of the treated meat.

Following treatment with non-ionizing radiation, the piece of intact meat is ground to produce ground chuck. The ground chuck is formed into a patty, and the patty is grilled “rare” for consumption.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

In some embodiments, a piece of intact meat can be treated by maintaining a surface of the piece of intact meat at a temperature substantially above 145° F. For example, in an embodiment, a piece of intact meat is submerged in 450° F. oil for only 3 seconds, and the intact meat is subsequently ground. Variations also include treatment at less than 145° F. For example, an embodiment includes maintaining a temperature of a surface of a piece of intact meat at 135° F. or greater, preferably for at least 10 seconds, more preferably for at least 15 seconds, and most preferably for at least 30 seconds.

Embodiments comprise treatment of intact meat with antimicrobial substances prior to grinding, the antimicrobial substances including, but not limited to, ozone; sodium chlorite; acidified sodium chlorite; chlorine or other halogens; aqueous halogen solutions; hypochlorite salt solutions; chlorine dioxide; organic acids and their salts; cetylpyridinium chloride; peroxides such as hydrogen peroxide or organic peroxides; salt solutions such as aqueous solutions of sodium chloride, potassium chloride, or other halide salts, and trisodium phosphate solutions.

1. A method of processing meat comprising:
providing a piece of intact meat;
partially cooking the piece of intact meat, said partially cooking the piece of intact meat including maintaining a surface temperature of the piece of intact meat at 1450 F or greater for at least 15 seconds;
producing ground meat by grinding the piece of intact meat, the piece of intact meat being partially cooked with a portion of an interior of the piece of intact meat being uncooked.

2-26. (canceled)
